(19) United States
(12) Patent Application Publication
(10) Pub. No.: US 2007/0100682 A1
(43) Pub. Date: May 3, 2007

(54) Method of conducting market research by means of strategically placed computerized kiosks

(76) Inventor: Lawrence Kazali, Beverly Hills, CA (US)

Correspondence Address: WHITE-WELKER & WELKER, LLC, P.O. BOX 199, CLEAR SPRING, MD, 21722-0199, US

(21) Appl. No.: 11/261,900

(22) Filed: Oct. 28, 2005

(51) Int. Cl. G06F 17/30

(52) U.S. Cl. 705/10

(57) ABSTRACT

The present invention is a method for conducting market research by means of strategically placed computerized kiosks that offer respondents various incentives for their participation. Respondents providing complete contact information are entered into a drawing for a prize, as well as, receive a coupon upon completing the market research questionnaire. The questionnaires then will be stored on a local sever that resides next to these kiosks. At the end of the day this server will start transmitting the information to a central sever using proprietary software to encrypt the data and transfer it via satellite to the central server. Once the central server receives the data it will decipher, analyze, and categorizes it and convert it into meaningful data separated by gender, age, location, and answers, then converts it into a desired format and sends it to the client as an email attachment before the end of the day. Results are available to the client over the Internet as each survey is completed due to cutting-edge technology. In addition to market research questionnaires, the present invention will generate income by selling contact lists and demographics to select clients as well as selling advertising in the form of coupon distribution and promotional giveaways. The present invention combines several desirable products or packages in one location. This combined effort exposes consumers to multiple advertising clients.

### FEDERALLY SPONSORED RESEARCH

Not Applicable

### SEQUENCE LISTING OR PROGRAM

Not Applicable

### CROSS REFERENCE TO RELATED APPLICATIONS

Not Applicable

### TECHNICAL FIELD OF THE INVENTION

The present invention relates generally to automated service kiosks. More specifically, the present invention relates to a method for conducting market research by means of strategically placed computerized kiosks that offer respondents various incentives for their participation.

### BACKGROUND OF THE INVENTION

Market research has been performed in one form or another for thousands of years, providing merchants and professionals with critical feedback about their services and products. With the invention of corporations, these merchants grew into enormous organizations that strive to keep in touch with their consumers, but have largely lost the ability to do so personally. Market research is often outsourced and gathered through telemarketing, new product registration, internet questionnaires, direct-mail inquiries, focus groups, and working with consumer groups.

Recent trends in the field of telemarketing show consumer resistance to gathering information via the phone. Groups have pressed for legislation resulting in do-not-call lists and registries on a state-by-state basis that impair the effectiveness of telemarketing research companies. For potential respondents who do not want to be contacted, the process is fairly simple to be made unavailable to telemarketers. Some states simply require a phone call while others have a form and a fee of up to $10. There is also a proliferation of digital phones, cellular phones, solicitor blocks on landlines, unlisted numbers, and Internet phone service where numbers are difficult to generate and potential respondents are sensitive to the minutes they spend on the phone each month.

New product registration is voluntary and delivers infrequent results. In addition to this, the respondents are consumers who have already acquired the product and do not provide the company with information from prospective customers who have not purchased their goods or services.

Focus groups and Internet surveys often offer consumers something in exchange for their participation. Focus groups provide in-depth feedback to the company and are ideal to use in conjunction with other research methods. Internet surveys provide valuable feedback to many companies but often are not noticed by Internet users. This is either because pop-ups and banners have become so commonplace that users do not usually pay attention to their messages before closing them or the surveys are not advertised enough to get a good response

Traditional forms of market research are plagued by structural time lags inherent with telephone or personal interviews and the additional disadvantage of being labor intensive. Others have attempted to remove these disadvantages by offering electronic terminals for collecting opinion data without significant time delays and the need for a large labor force. For example, U.S. Pat. No. 6,658,323 issued to Tedesco, et al. on Dec. 2, 2003 teaches a vending machine method and apparatus for encouraging vending machine customers to review a marketing promotion or to participate in a survey while making a purchase. Customers are immediately rewarded for providing their response to the marketing promotion that was previously presented or for providing their preferences or opinions.

The reward may be, for example, a complementary product, a discount on the customer's current or subsequent purchase, or a rebate. The vending machine ensures that it contains sufficient currency and products to meet the requirements of all active reward offers. The vending machine ensures that buyers are committed to making a purchase before offering a reward to a customer. Unscrupulous customers are discouraged from repeatedly participating in a marketing promotion merely to collect rewards or influence the results of a survey.

The system of the present invention will allow repeated participants to take as many surveys as desired. Upon entering their names, emails or addresses, the system immediately recognizes them from pervious activities and will provide them with a new survey for a different client, eliminating abuse and preventing and discouraging unscrupulous customers from repeatedly participating in a marketing promotion merely to collect rewards or influence the results of a survey. This is accomplished through our proprietary program that is installed into the kiosks that will recognize the participant from email, user name, id, or addresses. Once a participant is prompted to enter this information the system will immediately retrieve their previous activities and change the subject matter of the survey accordingly. The marketing promotion presented to a customer can be based on the customer's current or previous product selection(s) or purchase history.

Another example is U.S. Pat. No. 6,807,532 issued to Kolls on Oct. 19, 2004, which is a processing method for conducting e-mail, e-commerce, and e-business via an electronic commerce terminal. An electronic commerce terminal can be referred to as a pervasive computing device that relates to a universal advertising and payment system and method for networking, monitoring and effectuating e-mail, e-commerce, and e-business and controlling vending equipment and applications. The system can effectuate electronic commerce and interactive advertising at the point of sale.

Vending equipment includes copiers, phones (public, private, cellular), facsimile machines, printers, data-ports, laptop print stations, notebook computers, palmtop computers (PALM PILOT), microfiche devices, projectors, scanners, cameras, modems, communication access, personal data assistants (PDA's), pagers, and other vending machines, personal computers (PC), PC terminals (NET PC), and network computers (NC).

Vending equipment can be networked to each other through an initial network programmable and accessible by a PC, server, point of sale (POS) system, property or management information system (PMS/MIS), and then networked to a subsequent network. The initial and subsequent networks can be the same. Complete control of a vending machine's functionality including usage, control, diagnostics, inventory, and marketing data capture can be effectuated locally or by remote connection to the network. Remote connection to the network includes Internet type connections, telecommunication (telephone, ISDN, ADSL), VSAT satellite, and other wire and wireless transmission.

A disadvantage of the devices previously described and others known in the prior art is the lack of motivation to entice a potential respondent to engage the machine and provide an accurate input of survey data. Many potential respondents fail to realize any gain from completing a survey and will either avoid the situation completely or provide answers leading to the quickest or easiest completion of the survey process so they can move on to their next activity.

Therefore, it is an objective of the present invention to implement a method of conducting market research by means of strategically placed and designed computerized kiosks with respect to ornamental appearance and incentives used to entice potential respondents into providing survey data.

### SUMMARY OF THE INVENTION

The present invention is a method of conducting market research by means of strategically placed computerized kiosks that offer respondents various incentives for their participation. For example, a new car may be placed in a high-traffic shopping mall surrounded by six to eight kiosks. Respondents providing complete contact information are entered into a drawing for the vehicle as well as receive a coupon upon completing the market research questionnaire. The questionnaires then will be stored on a local sever that resides next to these kiosks.

The local kiosks will take the input from the participants and send it to a local server which is a hard drive located within the kiosks that collects information and answers from the participants. At the end of the day this local server will transmit the collected information via wireless modem to the central server. The central server then, through a customized data base will tabulate the answers, manipulate them, and change them into a readable report separated by genders, age, answers, locations, and calculate the total numbers of such gender who answered as such and such age answered as such. A text report is then generated that is adaptable to any system that a client company may have. This report is then sent to the client company as an attachment via email while another copy remains on the central server. This process will be completed before a specific time such as midnight each day.

Periodically throughout the day, this server will transmit via satellite and encrypt the market research input using proprietary software to a central server. Once the central server receives the data, a proprietary database will decipher, analyze, categorize, and convert it into demographically sorted results. Then, the database will convert the results into an end-user compatible format, such as Excel or a PDF file, which is sent to the client as an email attachment. This process provides clients' immediate useful information needed to adjust their products and services and empower management with information to help them stay competitive.

The location of the kiosks and incentives for respondents will vary based on demographics of those targeted to participate in the research. In an alternative embodiment, results are available to the client over the Internet as each survey is completed due to cutting-edge technology rather than in one queue or file at the end of the day or given time period.

In addition to market research questionnaires, the present invention will generate income by selling contact lists and demographics to select clients as well as selling advertising in the form of coupon distribution and promotional giveaways. The present invention combines several desirable products or packages in one location. This combined effort exposes consumers to multiple advertising clients.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flow chart illustrating the method of conducting market research by means of strategically placed computerized kiosks in general and with respect to the specific circumstances of voting and polling;

FIG. 2 illustrates one potential distribution of the kiosk system at one location;

FIG. 3 illustrates the physical requirements of the kiosk system utilized by the present invention;

FIG. 4 is a flow chart illustrating participant requirements to be eligible for a drawing;

FIG. 5 is a flow chart illustrating the communication between a kiosk and the central server;

FIG. 6 is a flow chart illustrating the process of providing a coupon to a successful participant;

FIG. 7 is a flow chart illustrating the process of offering games and contests to participants.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Referring to the figures, it is possible to see the various major elements constituting the apparatus of the present invention. The invention is a method for conducting market research by means of strategically placed computerized kiosks that offer respondents various incentives for their participation.

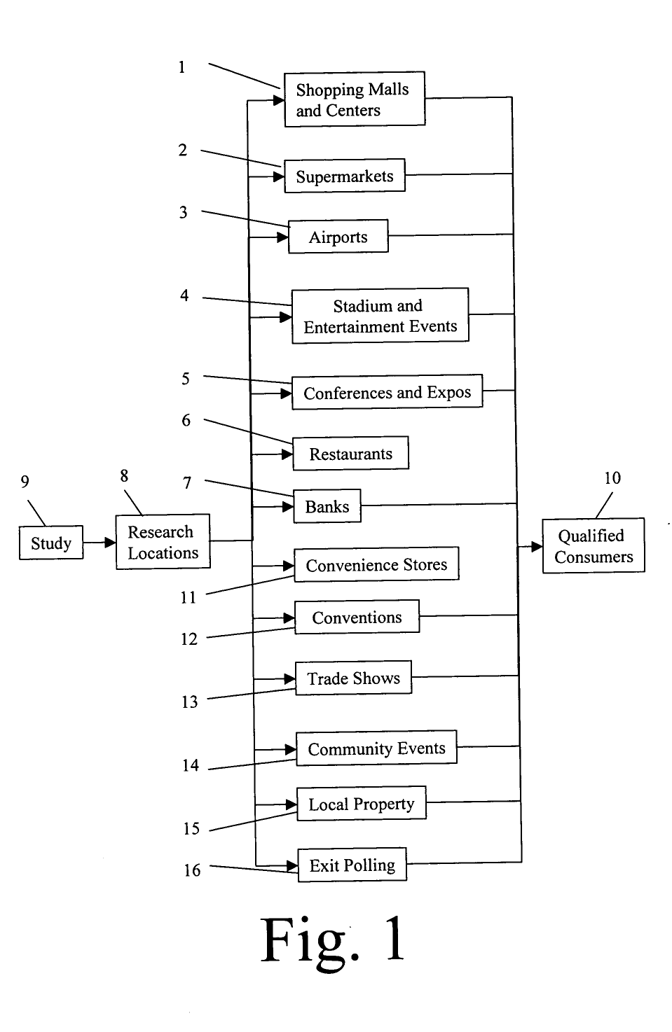

Now referring to FIG. 1, the present invention first provides a study 9 that will seek out research locations 8 where a large number of qualified consumers 10 are likely to be found. Depending on the nature of the study, this may include shopping malls and centers 1, supermarkets 2, airports 3, stadiums and entertainment events 4, conferences and expos 5, restaurants 6, banks 7, convenience stores 11, consumer and business conventions 12, trade shows 13, community events 14, and on the client's property 15. Research locations 8 may also be extended to include political exit polling 16 conducted where individuals are voting instead of using interviewer administered paper questionnaires that are then called in by phone. These polling uses of the kiosks may also extend to other events and competitions that involve voting and immediate feedback from large numbers of people.

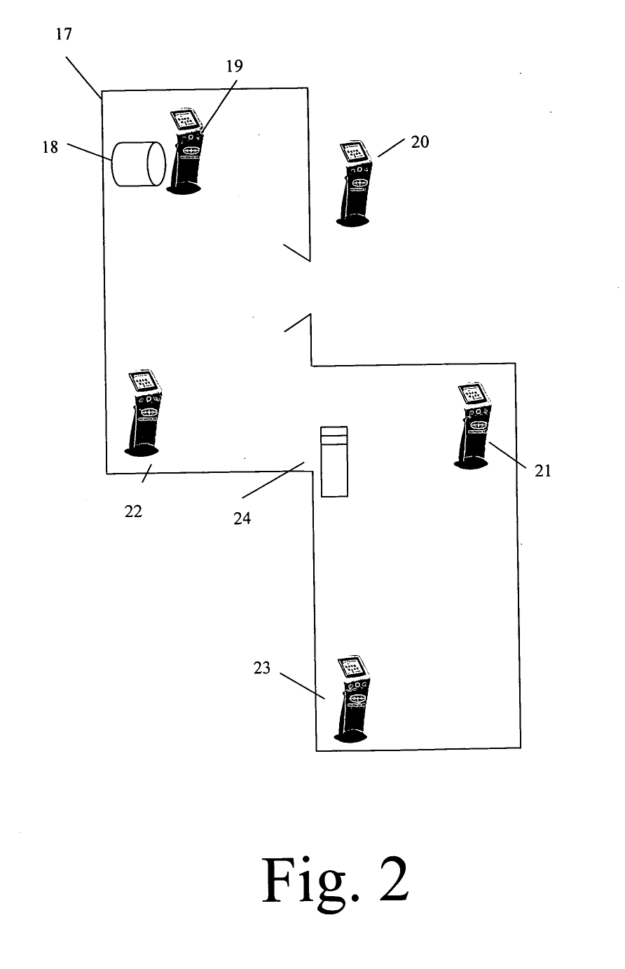

FIG. 2 illustrates one potential deployment of the kiosk system of the present invention. One possible deployment could occur at a research location 8 such as a mall or shopping plaza 17 where a large number of qualified consumers 10 are likely to be found. In this deployment scenario multiple kiosks 19-23 are located a various locations inside and outside of the shopping plaza 17. The kiosks 19-23 are each shared over a local network server 18.

Multiple kiosk locations 19-23 enable the collection of simultaneous surveys at one research location 8. Deployment need not be confined to one research location 8, but can be repeated for any number of research locations 8 further comprising any number of local kiosks at any and every research location 8. The method of the present invention teaches a system with the ability to conduct simultaneous surveys resulting in an increased saving of time and money when compared with current systems and others known in the prior art. The system of the present invention connects multiple research locations and multiple kiosk placements to one central server, resulting in an economy of scale advantage over known prior art systems because millions of surveys may be completed and reported in a short period of time.

Periodically throughout the day, the local network server 18 will transmit and encrypt the market research input using proprietary software to a remote central sever 82. Next, the database 52 located on remote central sever 82 will convert the market research into an end-user compatible format, such as Excel or a PDF file, which is sent to the client company 57 as an email attachment upon request or any scheduled time. The database 52 stored on the central server 82 will summarize the answers in a report based on location, zip code, and median general household income of respondents. The file will contain detailed information of survey results for the reporting period such as gender, age, location, and answers by utilizing text, bars, and other graphical displays.

Upon receipt of the file, the client company 57 may enter the results into the system and be able to have a better “vision” of their products and services from any remote location. The system provides means for allowing the client company 57 to access the central database 48 at any time from any remote location that can assess the network wherein said client company 57 may make changes to the visual display, questionnaires or a plurality of other information displayed or requested by respondents through the kiosks. This ability to provide the client company 57 the means for adjusting their product displays, reward programs, discounts, prices, or services is not taught in the prior art. This provides a benefit to the client company 57, that being enhanced productivity, product adjustments in response to consumer feedback, and financial savings.

In an alternative deployment, multiple kiosks 19-23 are located a various locations inside and outside of a shopping plaza 17. The kiosks 19-23 are each shared over a local network server 18 as previously discussed. In this alternative embodiment, the kiosk generates two coupons to a respondent upon successful completion of a survey. A first coupon is valid for redemption at a research location 8. A second coupon 52 is valid for placement in a single drawing box 24 located within the research location 8.

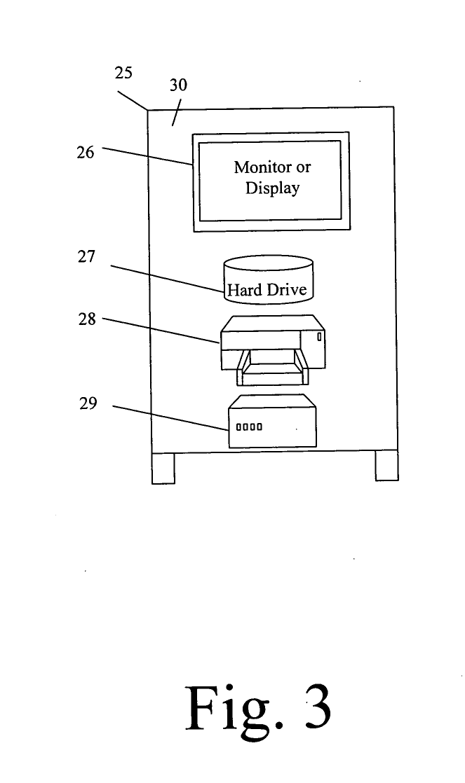

Now referring to FIG. 3, the unmanned kiosk 25 will be similar to an ATM machine in construction in that the hard drive 27, monitor 26, printer 28, and wireless connection to an internal server 29 will be securely encased 30 within each unmanned kiosks 25. Wireless technology will be used to relay information from an unmanned kiosk's 25 internal server 29 to a local server 24 located at a research location 8, and then from the local server 24 to a remote central sever 82 for specified information processing. An internal printer 28 will be used to issue valuable coupons 61 to the participant 10, which may be customized according to their responses or may be the same for all respondents, depending on the arrangement with the client company.

The ornamental appearance of the unmanned kiosks will be enhanced far beyond that of an ATM to look modern and reflect cutting-edge technology. For long-term clients or clients requesting customization, kiosks will be built to reflect the client's image, products, and services. For example, a survey for a car manufacturer may include the color and prominently displayed logo of the client. If the client wishes to remain anonymous, the kiosk may be designed to reflect features or images of a car without disclosing the identity of the client.

Since there are no interviewers conducting surveys, respondents are expected to complete surveys more quickly and are less likely to be biased by an interviewer. Each kiosk will be positioned so as to provide maximum privacy to the respondent as they participate in the research.

Considering that consumers are continually bombarded with advertisements and market research, one goal of the present invention is to carefully develop incentives to attract participants. Large prizes, such as a vehicle or vacation, will be prominently displayed and given away in a drawing of all those who participated. When an individual completes a questionnaire, they will also be given a valuable coupon as thanks for their participation. Prizes and coupons will be designed to appeal to those individuals that the client company wants to participate in their research.

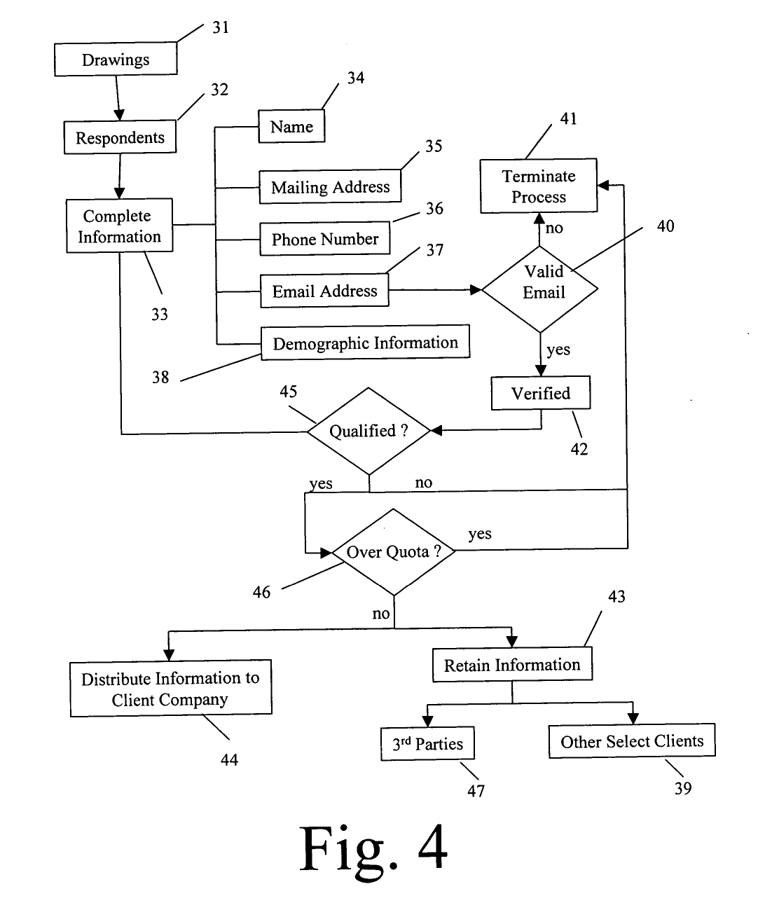

Now referring to FIG. 4, to be eligible for drawings 31, such as to win an automobile or vacation, respondents 32 must enter correct and complete information 33, including their name 34, mailing address 35, phone number 36, email address 37, and demographic information 38 as needed. To qualify to complete the questionnaire and receive a valuable coupon, the respondent 32 must provide a verifiable email address 37. Upon providing the email address 37, the present invention will immediately and automatically verify 40 the email address 37 for a response. If an invalid email address is entered the process will terminate 41, otherwise the email will be verified 42.

The complete respondent information 33 will be provided to the client company 57 and retained locally 43 to potentially sell to selected third parties 47. Complete information 33 provided to the client company 57 will first be received by a central server 82. Periodically throughout the day, the local network server 18 will transmit and encrypt the market research input using proprietary software to a remote central sever 82. Next, the database 52 located on remote central server 82 will convert the market research into an end-user compatible format, such as Excel or a PDF file, which is distributed 44 to the client company 57 as an email attachment upon request or any scheduled time. A copy of the file will be stored locally 43 on the remote central server 82 in addition to the copy transmitted to the client company 57.

All information provided by respondents 32 will be distributed 44 to the client company 57. The system of the present invention will also retain some of this information, such as contact and demographic information 38, unless other arrangements are made with the client company 57. The system of the present invention may then sell this information 38 to select other clients 39, further expanding its research capabilities as well as generating additional revenue.

The personal and demographic information 38 of respondents 32 will be used to ensure that the respondent 32 is qualified 45 to take part in the study 37, does not exceed desired quotas 46, and does not participate repeatedly 39. If a drawing is held and their name selected, but their information is not valid, another participant with correct information will receive the prize instead. This is designed to provide the client company 57 with accurate and reliable information.

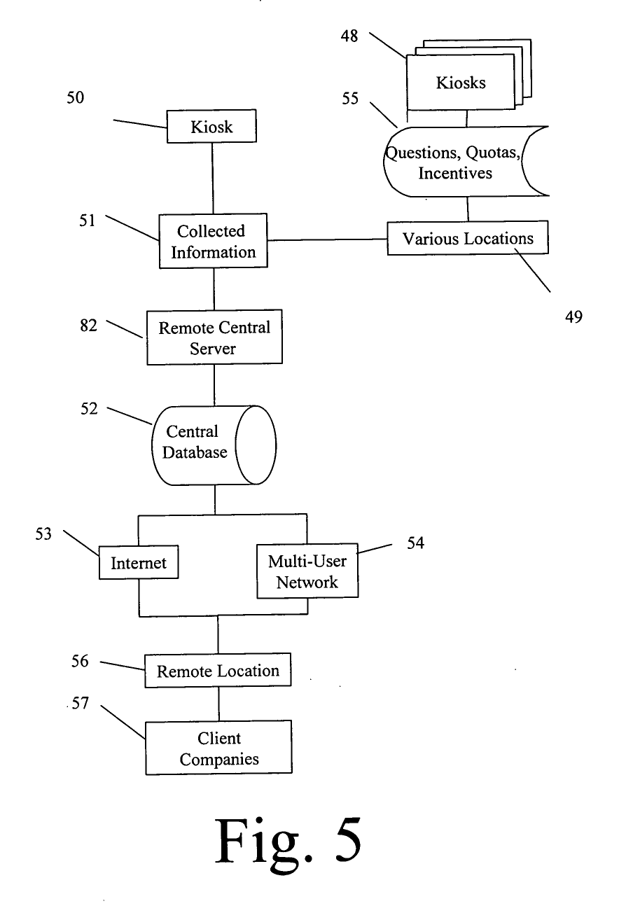

As illustrated in FIG. 5, each kiosk 50 will be connected to a central database 52. This central database 52 relays collected information 51 to a client company 57 periodically throughout the day or at any interval desired from instantaneous to any amount of time making it accessible to client companies 57 through the Internet 53 or other multi-user network 54. Upon receipt the client company 57 may import the file into a proprietary system for distribution of the information in its entirety or selected parts to various departments.

Additionally, the system also provides means for allowing the client company 57 to access the central database 48 at any time wherein said client company 57 may make changes to the visual display, questionnaires or a plurality of other information displayed or requested by respondents through the kiosks. Questions, quotas, and incentives 55 may be changed from a remote location 56 for one or more kiosks 48 located in different areas 49. Respondents' email addresses are also verified immediately and prior to issuing them a valuable coupon as a reward for their cooperation in the study. Prizes offered in drawings may include new automobiles, TVs, ATVs, computer equipment, spa packages, home improvement or other shopping sprees, travel packages, or other large products and packages.

Multiple prizes may be offered in one place to attract respondents. Suppliers of the prizes will be approached and asked to participate in the program by contributing a free or discounted product in exchange for the advertising that will occur at the high foot-traffic research site. The advertising companies will be able to list all of their contact information and ideally receive increased business and awareness as a result of their collaboration. The research clients may also provide give-away prizes or coupons.

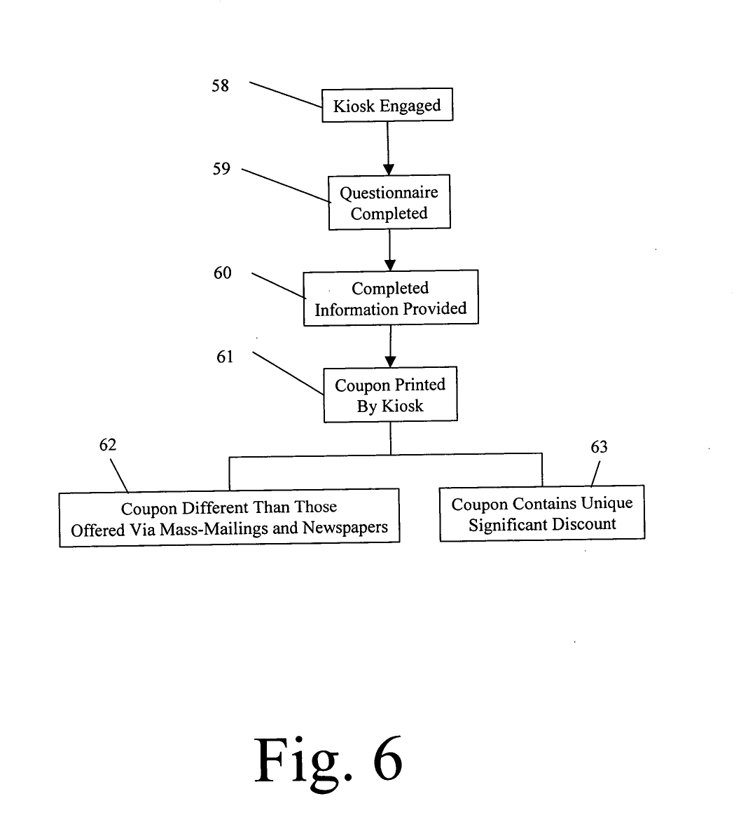

Now referring to FIG. 6, after completing the questionnaire 59 and providing all required information 60, the kiosk 58 will print off a valuable coupon 61 for nearby stores, restaurants, or services. These coupons are not like ones the entire community receives through mass-mailings or newspaper inserts 62, but offer significant discounts 63. For example, a respondent may receive a coupon for a free dessert or drink at a nearby restaurant or bar.

In an alternative embodiment betting and contests will be offered through similarly designed kiosks strategically placed in areas with high foot traffic or where potential participants may be most likely to participate. Some such places include airports (since people are waiting), bars and clubs (potential participants are looking for entertainment), and other such places. The kiosks will have a durable protective outer housing that contains the computer, keyboard, screen, and a connection to the server for transferring information.

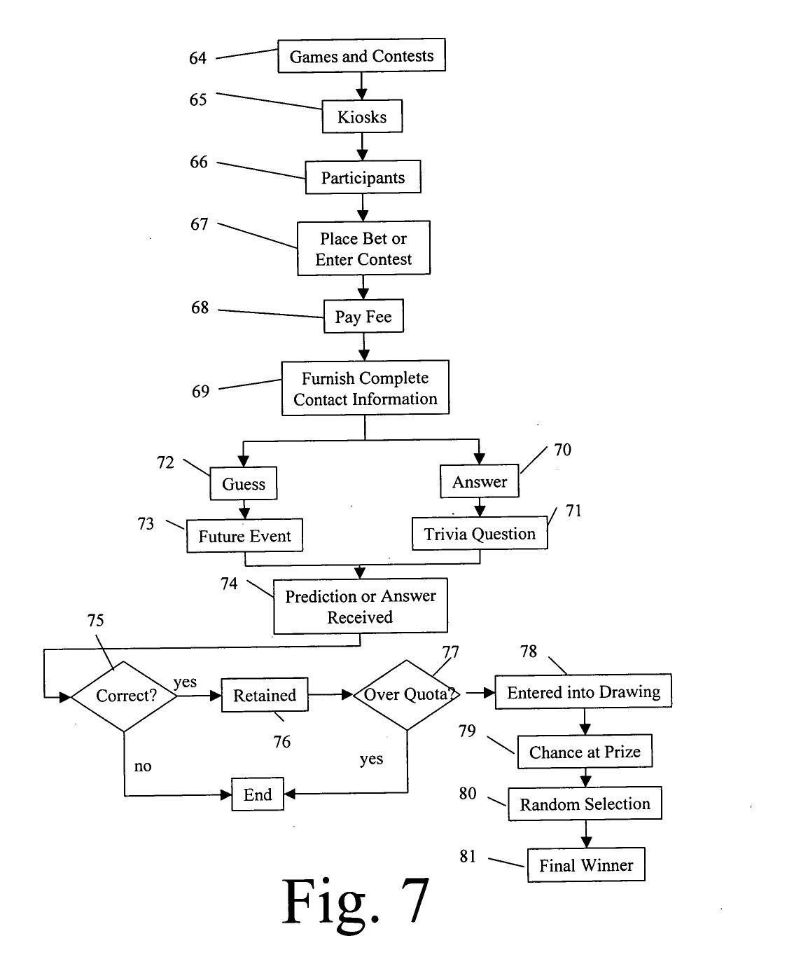

Now referring to FIG. 7, the games and contests 64 offered through the kiosks 65 will combine betting or trivia with lottery-style drawings. To place a bet or enter a contest 67, participants 66 will be required to pay a fee 68 ranging from a dollar to twenty or more, depending on the prize. They must also furnish their complete contact information 69 so that they may be notified if they win. This complete contact information 69 will then belong to the system of the present invention for resale similarly as is done with the market research kiosks.

After payment 68 and entry of contact information 69, participants 66 guess 72 at a future event 73, such as with sports, or answer 70 trivia questions 71, such as games attracting youth. Once their prediction or answer 74 has been received, it will be retained 76 in the system. If the answer or prediction is correct 75, their name will be entered into a drawing 78 along with all of the other right answers 79 for a prize. The final winners 81 are chosen at random 80. The number of entries 77 is limited to guarantee participants certain odds of winning.

Under-aged players will be required to have parental consent to participate and furnish personal information. Potential prizes for the drawings include new luxury automobiles, home improvement shopping sprees, water or land recreational vehicles, luxury travel packages, tickets to sporting or entertainment events, and other prizes that are complimentary to the betting format. Younger players may be eligible to win learning software, family vacation packages, new bicycles or outdoor equipment, room make-overs, season passes to nearby amusement or water parks, new computers, school-related prizes, and other prizes both parents and children would find attractive

In an alternative game embodiment for adults, after a fee is paid the kiosk will present a respondent with an image of a sporting event such as a football player attempting to catch a football or kicker attempting to make a field goal. The respondent is then required to predict the location of the ball in the image by pointing a finger on the monitor. In this example, the player pays his money, not knowing how many potential locations are available (i.e. not taken by previous respondents).

In yet another alternative game embodiment for children, after the payment of a fee, a kiosk will present an image of a rotating globe of the earth containing real satellite images of the Earth's surface. A respondent is then required to select a part of the Earth by placing a finger on the rotating globe. Once an Earth location is located a series of multiple choice questions will be asked to the respondent such as Country, City Name, and Capital. Respondents will enter their answers and be notified if they are a winner upon completion of the question set.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A method of conducting market research by means of strategically placed computerized kiosks comprising:
providing a study that will seek out research locations where a large number of qualified consumers 10 are likely to be found;
one or more survey kiosks located at identified research locations comprising:
a hard drive for storing and controlling survey administration;
a monitor for displaying survey information;
a printer for issuing one or more coupons to participants upon successful completion of a survey;
a local server;
a connection for communicating and transmitting survey information from said local server to a remote location;
a central server located at a remote location for receiving survey information transmitted from said survey kiosks; and
wherein all information provided by participants is relayed by said central server to a client company by said connection for communicating and transmitting survey information to a remote location using a multi-user network; and
said central server retains said participant information, such as contact and demographic information for resale to third parties in a central database.

2. The method of conducting market research by means of strategically placed computerized kiosks of claim 1 wherein said survey information is shared locally from each of said kiosks to the local server and is encrypted and transmitted to the central server periodically or upon demand by a client.

3. The method of conducting market research by means of strategically placed computerized kiosks of claim 2 wherein the database stored on the central server summarizes respondent answers in a report based on location, zip code, and median general household income of respondents.

4. The method of conducting market research by means of strategically placed computerized kiosks of claim 3 wherein said file will contain detailed information of survey results for the reporting period such as gender, age, location, and answers by utilizing text, bars, and other graphical displays.

5. The method of conducting market research by means of strategically placed computerized kiosks of claim 4 wherein the central server provides means for
allowing the client company to access the central database at any time from any remote location that can assess the network wherein said client company can make changes to the visual display, questionnaires or a plurality of other information displayed or requested by respondents through the kiosks.

6. The method of conducting market research by means of strategically placed computerized kiosks of claim 1 wherein said coupons are customized with respect to participant responses.

7. The method of conducting market research by means of strategically placed computerized kiosks of claim 6 wherein the kiosk generates two coupons to a respondent upon successful completion of a survey.

8. The method of conducting market research by means of strategically placed computerized kiosks of claim 7 wherein
the first coupon is valid for redemption in research location; and
the second coupon is valid for placement in a single drawing box located within the research location.

9. The method of conducting market research by means of strategically placed computerized kiosks of claim 1 wherein simultaneous surveys are conducted at a plurality of research locations via a plurality of survey kiosks at each research location.

10. The method of conducting market research by means of strategically placed computerized kiosks of claim 2 wherein after said information is transmitted to the central server, said central server receives the data and a database deciphers, analyzes, categorizes, and converts it into demographically sorted results.

11. The method of conducting market research by means of strategically placed computerized kiosks of claim 4 wherein said database converts the results into an end-user compatible format file that is then transmitted to a client.

12. The method of conducting market research by means of strategically placed computerized kiosks of claim 10 wherein, upon receipt of survey information from the central server, the client company may import the survey information file into a proprietary system containing means for distribution of the survey information file in its entirety or selected parts to one or more departments.

13. The method of conducting market research by means of strategically placed computerized kiosks of claim 3 wherein said research locations include events and competitions that involve voting and immediate feedback from a plurality of people.

14. The method of conducting market research by means of strategically placed computerized kiosks of claim 3 wherein said research locations include political exit polling conducted where individuals are voting.

15. The method of conducting market research by means of strategically placed computerized kiosks of claim 1 wherein each kiosk will be positioned so as to provide maximum privacy to the participant during interaction with a kiosk.

16. The method of conducting market research by means of strategically placed computerized kiosks of claim 1 wherein a kiosk's appearance reflects the client's image, products, and services.

17. The method of conducting market research by means of strategically placed computerized kiosks of claim 1 wherein a kiosk's appearance reflect features or images of a product or service without disclosing the identity of the client.

18. The method of conducting market research by means of strategically placed computerized kiosks of claim 1 wherein prizes, designed to appeal to those individuals that the client company wants to participate in their research, are prominently displayed and given away in a drawing of all participants.

19. The method of conducting market research by means of strategically placed computerized kiosks of claim 1 wherein to be eligible to receive a coupon, participants must:
provide a verifiable email address which will immediately and automatically be verified by said hard drive by pinging the email address for a response; and
acknowledge and agree that collected information will be provided to the client company as well as be retained by the system of the present invention for sale to selected third parties.

20. The method of conducting market research by means of strategically placed computerized kiosks of claim 18 wherein to be eligible for prizes participants must enter correct and complete information including: name, mailing address, phone number, email address, and demographic information as requested.

21. The method of conducting market research by means of strategically placed computerized kiosks of claim 19 wherein said participant information is used to ensure that the participant:
is qualified to take part in the study,
does not exceed desired quotas of participants eligible to win said prize;
does not participate the same survey repeatedly;
if participant has already completed one or more surveys before, said participant will take different surveys for different clients or different companies as available.

22. The method of conducting market research by means of strategically placed computerized kiosks of claim 1 wherein said central server retains said participant information, such as contact and demographic information for resale to third parties.

23. The method of conducting market research by means of strategically placed computerized kiosks of claim 1 wherein said survey, said prize quotas, and coupons may be changed from a remote location for one or more kiosks located in different areas.

24. The method of conducting market research by means of strategically placed computerized kiosks of claim 1 further comprising betting and contests.

25. The method of conducting market research by means of strategically placed computerized kiosks of claim 24 wherein:
to place a bet or enter a contest, participants are required to pay a fee;
participants must also furnish their complete contact information;
said complete contact information then belongs to the system of the present invention for resale;
after payment and entry of contact information, participants guess the outcome of a future event or answer trivia questions;
once said prediction or answer has been received, it will be retained in said hard drive;
if the answer or prediction is correct the participant's name will be entered into a drawing along with all of the other right answers for a prize on said central server;
the final winners are chosen at random from a correct participant database located on said central server.

26. The method of conducting market research by means of strategically placed computerized kiosks of claim 25 wherein said fee depends on the prize value.

27. The method of conducting market research by means of strategically placed computerized kiosks of claim 25 the number of entries is limited to guarantee the minimum odds of winning.
